(19) United States
(12) Patent Application Publication
(10) Pub. No.: US 2011/0025004 A1
(43) Pub. Date: Feb. 3, 2011

(54) Molded and Stackable Evacuation Sled

(76) Inventor: Nathan R. Walkingshaw, Bountiful, UT (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/533,911

(22) Filed: Jul. 31, 2009

(51) Int. Cl. B62B 15/00

(52) U.S. Cl. 280/19; 5/628

(57) ABSTRACT

A moldable and stackable evacuation sled that can also be used as a temporary surge capacity bed includes a dual-layer molded sled body having an air space between an inner layer and an outer layer. The sled body has a low-friction bottom surface, a bearing surface having a length and width that renders the bearing surface capable of receiving a human in a prone position, and upturned head, side, and foot portions that are substantially contiguous with the bearing surface and with each other. The sled body also includes a plurality of holes formed in at least the side portions, where the holes are adapted to receive a strap. A circumferential strap is threaded through at least a portion of the holes. Tow straps pass through other holes and loop around the circumferential straps.

### BACKGROUND OF THE INVENTION

1. Field of the Invention

The present invention relates to evacuation devices, and more particularly to an evacuation sled that can be used for evacuation and temporary surge capacity.

2. Background and Related Art

Several attempts have been made to provide evacuation methods and systems that can be used at facilities such as rest homes, assisted living facilities, hospitals, and other multi-level facilities like hotels, motels, and large business buildings or complexes, among other locations. In these locations, sometimes large numbers of individuals must be evacuated in short periods of time in cases of emergency. Many times, a large percentage of individuals in these facilities who need evacuation are unable to walk and leave the facility under their own power. This may be due to the reason the persons are in the facility originally, or may be due to injuries sustained in the course of the emergency necessitating evacuation.

In recent years, with the increase in awareness of preparedness issues, including those surrounding the possibility of terrorist attack, more of these facilities have sought to improve their preparedness for such events. However, no method has been provided that adequately addresses all of the needs of these types of facilities on encountering an emergency. For example, a hospital seeking to evacuate patients might have a patient-to-staff ratio of five-to-one. A nursing home or other similar facility often has a patient-to-staff ratio approaching ten-to-one. In emergencies, staff members may become injured or abandon their duties, further exacerbating the patient-to-staff ratio. Therefore, any method for evacuation must be rapid and ideally should permit evacuation on a low rescuer-to-evacuee ratio.

In fires or an earthquake, debris often clogs hallways and elevators become unusable. To deal with this situation, an effective evacuation system must be able to traverse nearly any kind of terrain, and must be able to descend or even ascend stairways. In part because of the need to cover varying kinds of terrain and to facilitate evacuation with as few staff as possible, an evacuation mechanism should ideally be lightweight and maneuverable. An evacuation device should also roll or slide easily on most types of terrain to allow as few people as possible to transport an evacuee in most situations.

Many patients being evacuated have special needs. Sometimes patients have broken bones or other injuries that require protection from jostling, or have spinal or other injuries where too much flexibility in the evacuation device could cause further injury or unnecessary pain. To prevent this, an ideal evacuation device should be strong and reasonably rigid, and should protect the evacuee from rough contact with the evacuation environment as much as possible. At the extreme end of patient needs are those patients with severe injuries requiring persistent intensive care to prevent the patients' death. An effective evacuation device should permit such care to continue unabated during and after an evacuation so that any type of patient may be evacuated.

Potential evacuees come in all shapes and sizes, so an evacuation device should be acceptable for use with a broad range of patients. This becomes especially important as a patient is transported up or down stairs. Thus the evacuation device should be flexible in its use. Of course, hospitals and other facilities that need to provide for the possibility of rapid evacuation hope never to have to perform an evacuation and hope never to use their evacuation devices. Since it is anticipated that the devices will be used rarely if ever, an ideal device should be relatively inexpensive to manufacture and purchase.

Also because evacuation devices are only rarely used, they should be readily stored in a manner that does not consume expensive storage space. The storage should ideally occur in an accessible place that is close to the location where the evacuation mechanism will eventually be used. Thus the evacuation device should store in a compact manner in a location that is readily accessible and close to potential evacuees.

Many times, successful evacuation is not the end of the story. In a serious emergency where a hospital facility is damaged, for example, evacuation of the patients from the hospital is merely the first step. In an emergency such as an earthquake, the patients will likely have to be cared for at whatever location to which they have been evacuated, which might be the grounds outside the hospital. In addition, in a serious emergency, hundreds or thousands of additional patients might be arriving for treatment, besides those being evacuated. Therefore, an ideal evacuation device should be able to double as a temporary bed to provide surge capacity for patients, both evacuees and new patients, until a more permanent solution to the emergency capacity needs can be devised.

In U.S. Pat. No. 7,422,220 to Nathan R. Walkingshaw et al., an evacuation sled and temporary surge capacity bed was disclosed to address the above situations.

### BRIEF SUMMARY OF THE INVENTION

Implementation of the invention provides a moldable and stackable evacuation sled that can also be used as a temporary surge capacity bed. The sled may be a dual-layer molded and stackable evacuation sled that includes a dual-layer molded sled body having an inner layer, an outer layer fixedly connected to the inner layer, and an air space between the inner layer and the outer layer. The sled body may have a low-friction bottom surface of the outer layer, a bearing surface having a length and width that renders the bearing surface capable of receiving a human in a prone position, an upturned head portion that is substantially contiguous with the bearing surface and that is located at a head end of the bearing surface, a pair of upturned side portions that are substantially contiguous with the bearing surface and the head portion, and an upturned foot portion that is substantially contiguous with the bearing surface and the side portions and that is located at a foot end of the bearing surface. The sled body includes a top edge where outermost portions of the inner layer and outer layer meet, the top edge extending around top ends of the head portion, the side portions, and the foot portion. The sled body also includes a plurality of holes formed in at least the side portions, where the holes are adapted to receive a strap.

In implementations of the invention, a circumferential strap is provided that is threaded through at least a portion of the holes. One or more tow straps may be passed through one or more additional holes and be looped around the circumferential strap. Thus, when towing forces are applied to the tow straps, the forces are distributed around the sled by the circumferential strap.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of an embodiment of a sled body;

FIG. 2 shows a perspective view of an outer layer of a sled body;

FIG. 3 shows a perspective view of an inner layer of a sled body;

FIG. 4 shows a side view of an inner layer of a sled body;

FIG. 5 shows a foot-end side view of an inner layer of a sled body;

FIG. 6 shows a perspective view of an inner layer of a sled body;

FIG. 7 shows a side view of an outer layer of a sled body;

FIG. 8 shows a perspective view of a cross-sectioned sled body;

FIG. 9 shows a perspective view of a cross-sectioned sled body;

FIG. 10 illustrates a strap arrangement for a sled embodiment;

FIG. 11 illustrates stacking of two sleds;

FIG. 12 illustrates interaction between a circumferential strap and a tow strap;

FIG. 13 shows a perspective view of a portion of a sled body;

FIG. 14 shows a perspective view of a portion of a sled body;

FIG. 15 shows a perspective view of a portion of a sled body; and

FIG. 16 shows a top view of a sled body.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a moldable and stackable evacuation sled that can also be used as a temporary surge capacity bed. The sled may be a dual-layer molded and stackable evacuation sled that includes a dual-layer molded sled body having an inner layer, an outer layer fixedly connected to the inner layer, and an air space between the inner layer and the outer layer. The sled body may have a low-friction bottom surface of the outer layer, a bearing surface having a length and width that renders the bearing surface capable of receiving a human in a prone position, an upturned head portion that is substantially contiguous with the bearing surface and that is located at a head end of the bearing surface, a pair of upturned side portions that are substantially contiguous with the bearing surface and the head portion, and an upturned foot portion that is substantially contiguous with the bearing surface and the side portions and that is located at a foot end of the bearing surface. The sled body includes a top edge where outermost portions of the inner layer and outer layer meet, the top edge extending around top ends of the head portion, the side portions, and the foot portion. The sled body also includes a plurality of holes formed in at least the side portions, where the holes are adapted to receive a strap.

In embodiments of the invention, a circumferential strap is provided that is threaded through at least a portion of the holes. One or more tow straps may be passed through one or more additional holes and be looped around the circumferential strap. Thus, when towing forces are applied to the tow straps, the forces are distributed around the sled by the circumferential strap. In other embodiments, the circumferential strap comprises a length sufficient to form a loop external to the sled body for towing the sled.

The inner and outer layers are fixedly joined at the upper edge, such as by heat welding, and may also be fixedly joined to each other proximate each of the holes, forming structure maintaining the air space around each of the holes. The inner and outer layers may also be fixedly joined to each other at a plurality of spacing indentations in one of the inner layer and the outer layer, thereby forming structures maintaining the air space along a bottom of the sled body.

In at least some embodiments, center points of each of the holes are each located at or above a vertical midline of the sled. In such embodiments, there are no openings of the sled below such holes, and therefore a bottom portion of the sled is essentially waterproof and can be dragged through snow, small amounts of water, or across damp or wet surfaces without any moisture reaching to the person being dragged in the sled.

The head portion, the side portions, and the foot portion extend upward and outward from the bearing surface. Because of this configuration, a plurality of the sleds can be stacked and nested together readily, and can therefore be stowed in a small volume of space, such as in a wall-hung container. Multiple sleds can therefore be stowed proximate a location of expected use for emergency preparedness and other benefits.

The sled may be readily towed with a towing harness and may be moved down an incline, such as stairs, by means of a rope and belay device. The sled has a low coefficient of friction and is lightweight. This allows the sled to be readily moved and handled without requiring the assistance of multiple people.

In cases where an evacuee requires a great deal of equipment for life support or other needs, additional sleds may be provided to carry that equipment. The equipment may be fitted into slots in a fitted foam insert that fills the sled, as disclosed in U.S. Pat. No. 7,422,220 to Nathan R. Walkingshaw et al., which is incorporated herein in its entirety by reference. Then the additional sleds may be moved with the evacuee to allow maintained support even during and after evacuation.

The sled may provide surge capacity for facilities like hospitals, as the sled is designed to be inexpensive and either disposable or reusable. Because of its low cost, the sled may be purchased in a number sufficient to allow one sled per anticipated evacuee, so evacuees may remain in their sleds post-evacuation until more a more permanent solution to bed needs can be provided. The sled may also be used to provide temporary surge capacity beds even if no evacuation occurs to provide capacity in the event of an emergency external to the hospital or other facility.

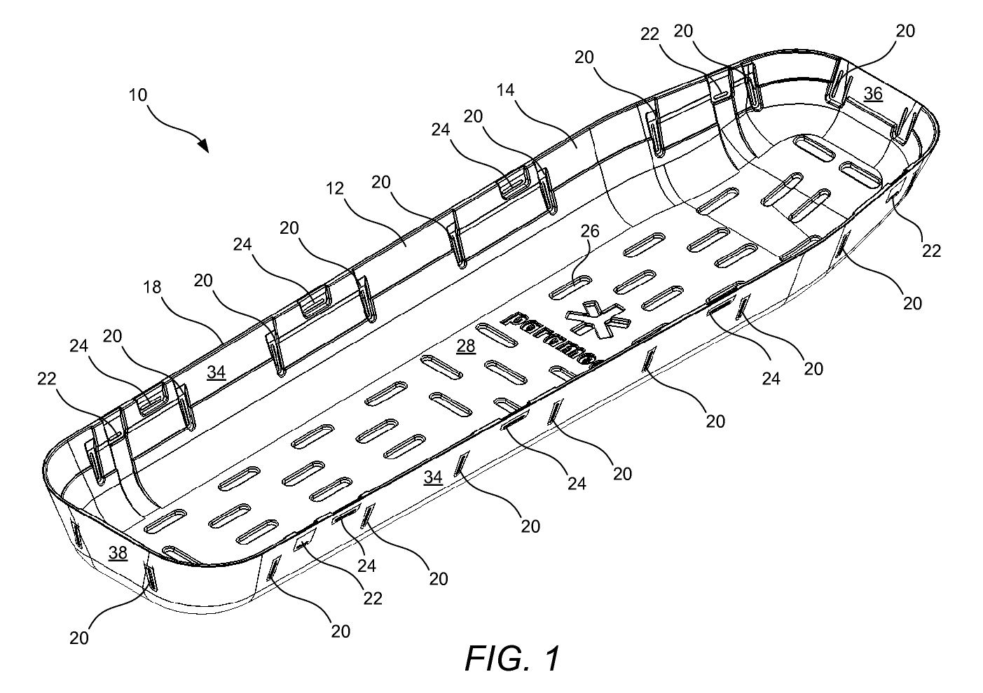

FIG. 1 shows a perspective view of one embodiment of a sled 10 illustrative of features of embodiments of the invention. The sled 10 is a dual-layer molded and stackable sled. The sled has a body 12 that is formed of two layers of material. The material may be any of a variety of materials, including plastics. As one example, the body 12 may be formed or molded out of two layers of polypropylene. This material is durable and has a fairly low coefficient of friction, which facilitates dragging of the sled during an evacuation. The material is also reasonably non-reactive and impermeable to bodily fluids and most materials encountered in an evacuation situation or other field of use, helping make the body 12 less prone to failure during use.

The sled body 12 is formed of two layers as discussed above, namely an inner layer 14 and an outer layer 16. While the inner layer 14 and the outer layer 16 may both be the same material (e.g. polypropylene), they may be manufactured of different colors or even different materials in some embodiments for aesthetic and functional reasons. For example, the outer layer 16 may be manufactured of a color that tends to minimize the appearance of scuffs, scrapes, and dirt, thereby maintaining the appearance of the sled 10 even after some use. As another example, the inner layer 14 may be manufactured of a color not prone to staining or showing stains made by bodily fluids. Alternatively, the inner layer 14 may be made of a color designed to maximize visibility of any bodily fluids to more quickly alert attending emergency personnel to the presence of such fluids. Other aesthetic and functional reasons may be considered in selecting the materials and colors of the inner layer 14 and the outer layer 16, as the above-recited considerations are merely exemplary.

The thickness of the inner layer 14 and the outer layer 16 may be chosen based on the materials used and their respective hardnesses, durabilities, and other characteristics to provide a range of desirable characteristics to the sled 10. It is anticipated that such variations are a matter of simple experimentation to determine desirable ranges for each possible material of which the inner layer 14 and the outer layer 16 can be manufactured. Nevertheless, by way of example only, when the inner layer 14 and the outer layer 16 are manufactured of polypropylene, the inner layer 14 and the outer layer may each have a representative thickness of between approximately 0.04 inches (or approximately 1 millimeter) and 0.12 inches (or approximately 3 millimeter), such as thicknesses of approximately 0.06 inches (approximately 1.5 millimeters) or approximately 0.09 inches (approximately 2.3 millimeters). It will be appreciated that the thickness may vary at different locations within the sled body 12 due to manufacturing variances and/or for functional reasons. For example, it is anticipated that bottom areas of the body may experience significantly greater wear, and may therefore be made thicker than other areas. As another example, areas of higher stress (such as various locations where straps are connected to the body 12) may be strengthened or made thicker.

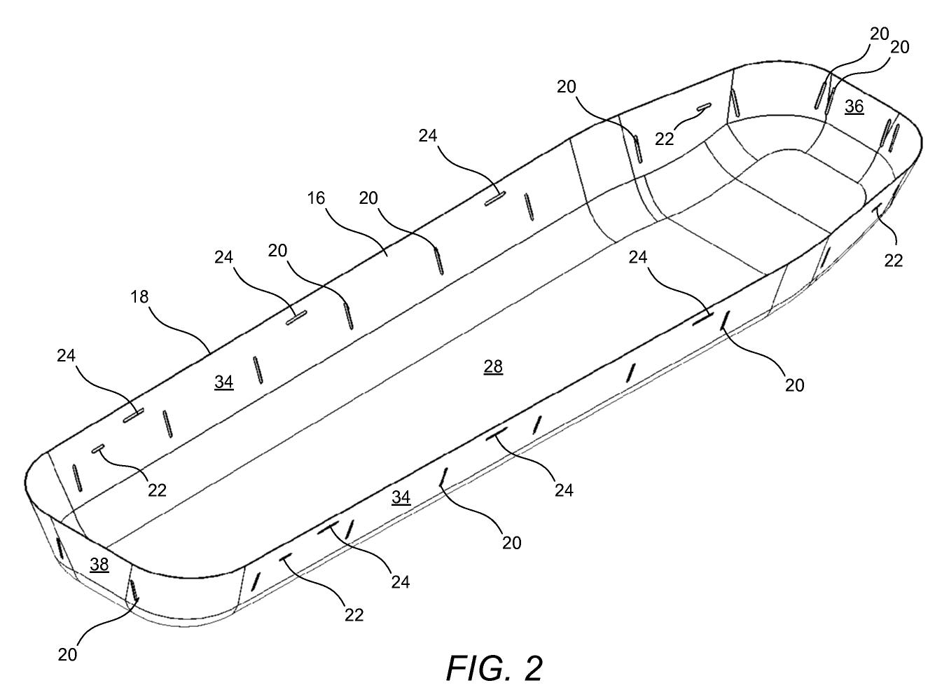

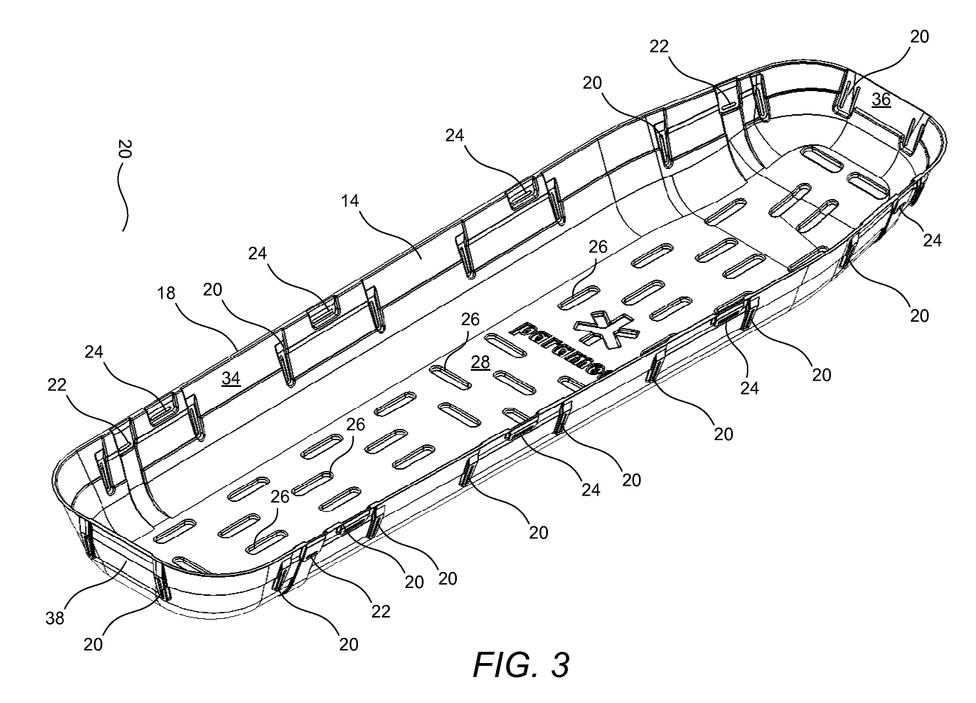

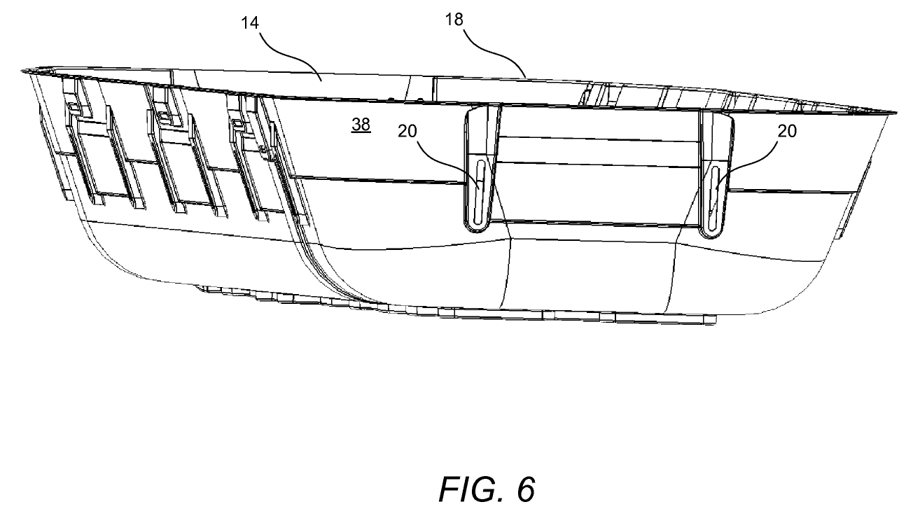

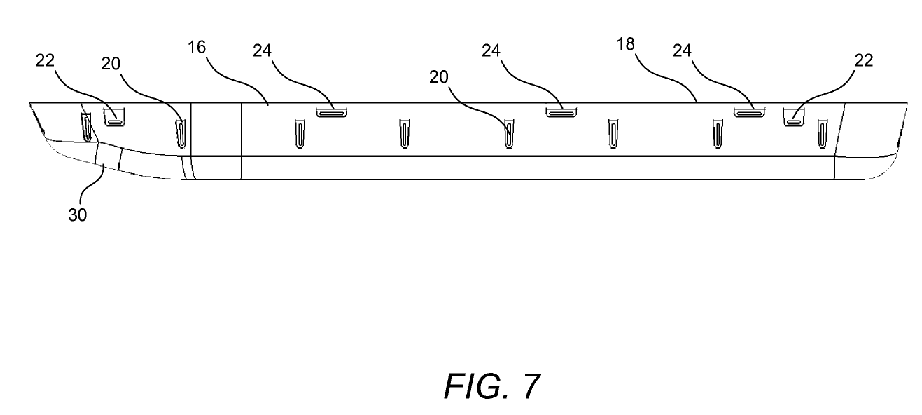

FIGS. 2 and 7 show views of the outer layer 16 in the absence of the inner layer 14, while FIGS. 3-6 show views of the inner layer 14 in the absence of the outer layer 16. The inner layer 14 and the outer layer 16 are fixedly attached or connected to each other, such as by being co-formed, heat welded, bonded, or otherwise attached to each other at various locations. The sled body includes a substantially-continuous upper rim 18. The upper rim 18 is one location where the inner layer 14 and the outer layer 16 may be connected. The inner layer 14 and the outer layer 16 may also be connected at any of a number of holes that may pass through the body 12 of the sled 10, including one of a circumferential strap hole 20, a tow strap hole 22, and a securing strap hole 24. The inner layer 14 and the outer layer 16 may also be connected at one or more spacing indentations 26 located in one or both of the inner layer 14 and the outer layer 16.

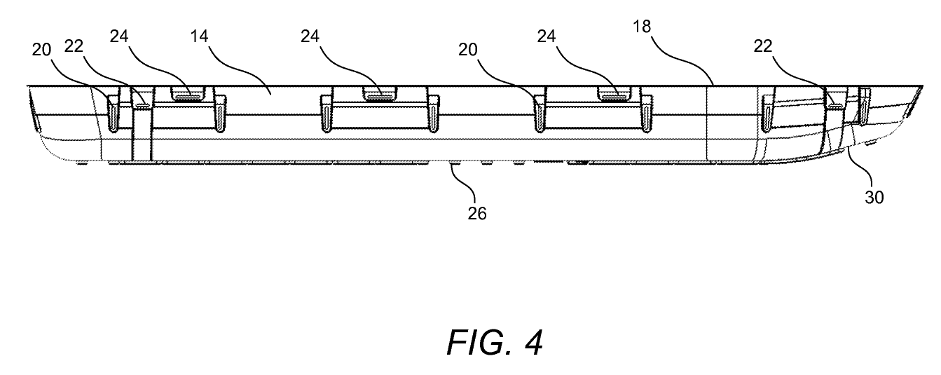

Although the spacing indentations 26, the circumferential strap holes 20, the tow strap holes 22, and the securing strap holes 24 may be located at a variety of locations on the body 12, the Figures illustrate a set of possible locations for such features. In the illustrated embodiments, the spacing indentations 26 are primarily located within a bottom portion 28 of the body 12. The bottom portion 28 includes a bearing surface (formed from the inner layer 14) that has a length and width capable of receiving a human in a prone or lying-down position, and a low-friction bottom surface (formed from the outer layer 16) whereby the sled 10 can be used to transport the human in this position. Of course, sleds 10 of different sizes having bearing surfaces/bottom portions 28 of different lengths and widths can be provided to fit different sizes of people. The bottom portion 28 may include a substantially-planar portion, and, as can be more clearly seen in FIGS. 4 and 7, a head end 30 of the bottom portion 28 may be angled upward somewhat, along with other areas surrounding the bottom portion 28. This upward angle of the body 12 permits a dragged sled 10 to more easily pass over bumps, stairs, and other obstacles that may be encountered while dragging a person in the sled 10.

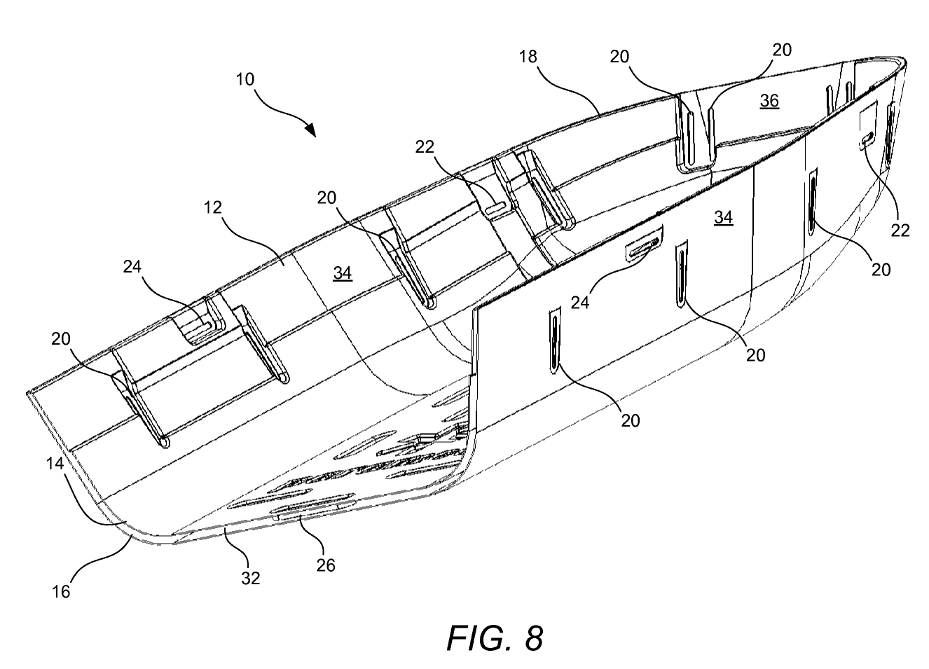

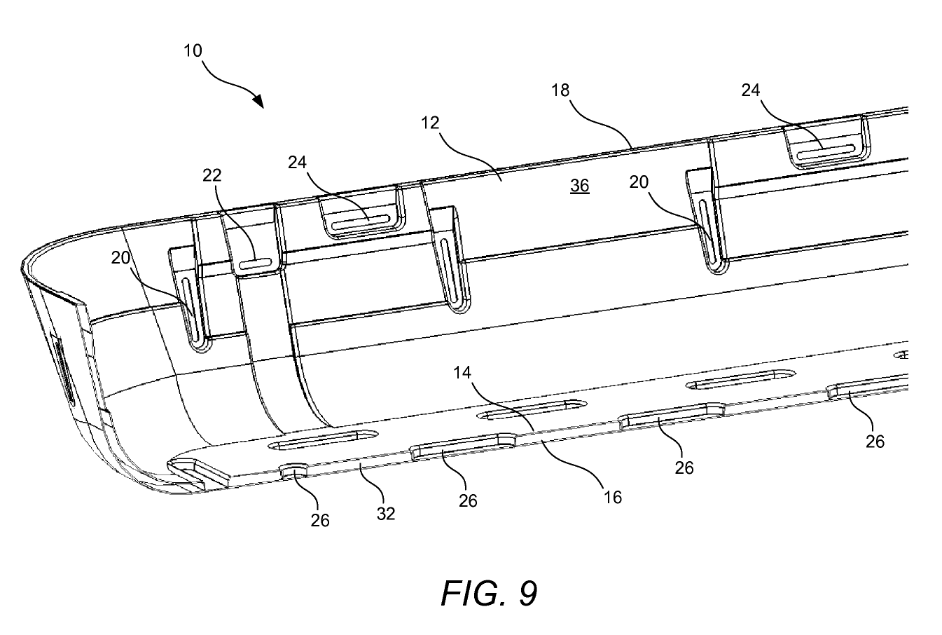

The spacing indentations 26 in the bottom portion 28 may be provided in a number and of a size and spacing to provide certain benefits to the sled 10. Such benefits include some shock absorption capabilities that reduce or minimize the transmission of bumps and other shocks encountered by the sled 10 during dragging to any person or equipment within the sled 10. Another benefit is an insulating benefit provided by an air space 32 maintained between the inner layer 14 and the outer layer 16 by the spacing indentations 26, as shown in FIGS. 8 and 9. The distance between the inner layer 14 and the outer layer 16 forming the air space 32 may be of varying sizes for any of various reasons (such as increased insulation, etc.), and may be varied to any distance between approximately 0.1 inches (approximately 2.5 millimeters) or even less up to as large as approximately 2 inches (approximately 50 millimeters) or even more, for example, approximately 0.5 inches (approximately 13 millimeters) or approximately 0.75 millimeters (approximately 19 millimeters).

Thus, the sled 10 provides some insulation to the person, even when the sled 10 is being used over snow or ice. Still another benefit is provided in the ability of the sled 10 to resist the entry of external moisture into the interior of the sled 10, even after significant wear has occurred (such as during a dragging operation). Because of the spaced-apart relationship between the inner layer 14 and the outer layer 16, a significant portion of the outer layer 16 can be abraded away during a dragging operation or otherwise, and the inner layer 14 often will not contact the underlying surface for a significant length of time due to the spacing indentations 26, thereby preventing or delaying wearing through the inner layer 14. Still another benefit is that the spacing indentations and the corresponding air space 32 provide some cushioning to the person in the sled 10, making the sled 10 more comfortable.

The circumferential strap holes 20 are located in at least a pair of upturned side portions 34 of the body 12 that are substantially contiguous with the bottom portion 28 of the body 12. The circumferential strap holes 20 may also be located in one or more of an upturned head portion 36 and an upturned foot portion 38. The circumferential strap holes 20 may be holes that are roughly vertically-oriented, and are therefore adapted to receive the passage of a flat strap to be woven through the circumferential strap holes 20. The weaving of a flat strap through the circumferential strap holes 20 provides a plurality of potential handholds on the flat strap, as controlled by positioning of the circumferential strap holes 20, whereby the sled 10 can be handled, carried, moved, etc. by one or more persons. As the flat strap passes through a plurality of the circumferential strap holes 20, any forces applied to the flat strap will tend to be passed by the flat strap to the sled body at more than one circumferential strap holes 20, thereby reducing the chance that the flat strap will tear out of the circumferential strap holes 20, and even if the flat strap tears out at one location, it will still be passed through the sled body 12 at sufficient locations to enable it to be used to apply forces to the sled 10.

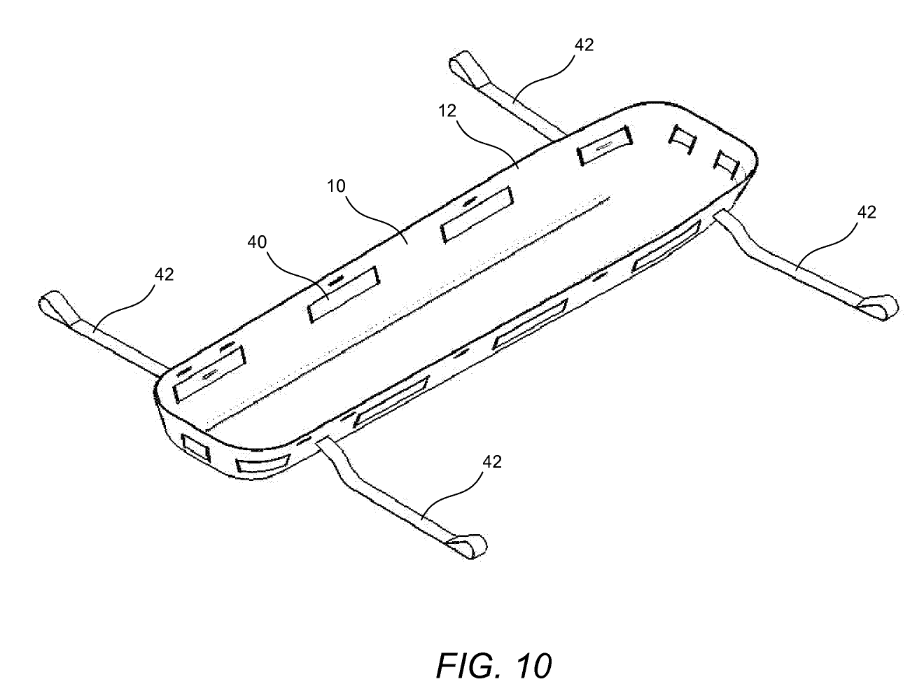

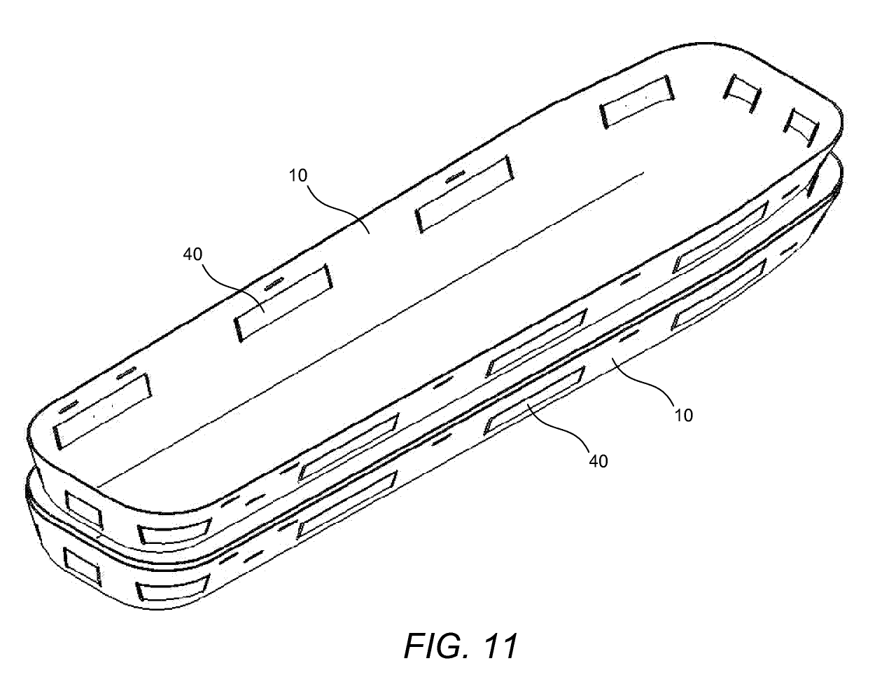

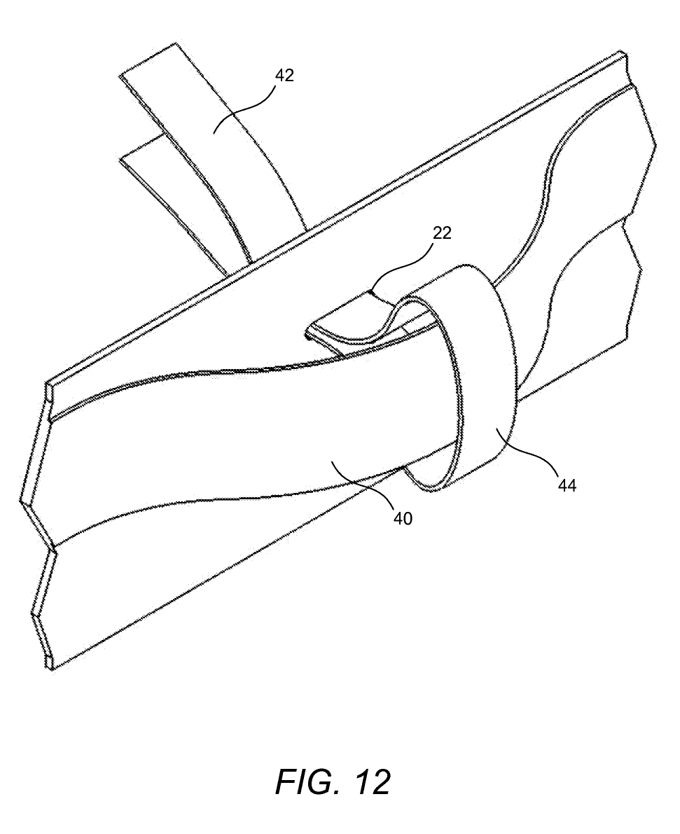

Although flat straps of various configurations can be used, one configuration of the flat strap is shown in FIGS. 10 and 11, namely a circumferential strap 40. The circumferential strap 40 shown in FIGS. 10 and 11 is a single, substantially-continuous strap that has been threaded through the circumferential strap holes 20 so as to pass completely around the circumference of the sled 10 (e.g. through/around both side portions 34, the head portion 36, and the foot portion 38). This provides significant structural strength to the sled 10, as the circumferential strap 40 may be capable of withstanding significantly greater localized forces than the sled body 12 may be able to withstand, and as the circumferential strap 40 passes such localized forces throughout the sled body 12. Thus, towing forces applied either to the circumferential strap 40 or applied to one or more tow straps 42 are not passed entirely at their point of origin to the body 12, but are distributed to the body 12 in a way that reduces the possibility of damage.

Where separate tow straps 42 are used, they may be provided in such a way as to transfer forces from the tow straps 42 to the circumferential strap 40, as illustrated in FIG. 12. As illustrated, at least a portion of the tow strap 42 forms a loop 44. The loop 44 of the tow strap 42 encircles a portion of the circumferential strap 40 and passes through the tow strap hole 22. Therefore, when force is applied to the tow strap 42, the force is passed primarily to the circumferential strap 40 for distribution to the entire body 12, instead of being passed to only a small location of the body 12. Other manners of securing the tow strap 42 or a similar towing device to the circumferential strap 40, including stitching or sewing, may be used. As an alternative, a length of the circumferential strap 40 may be lengthened so as to permit extension of one or more loops of the circumferential strap 40 to serve as one or more towing locations.

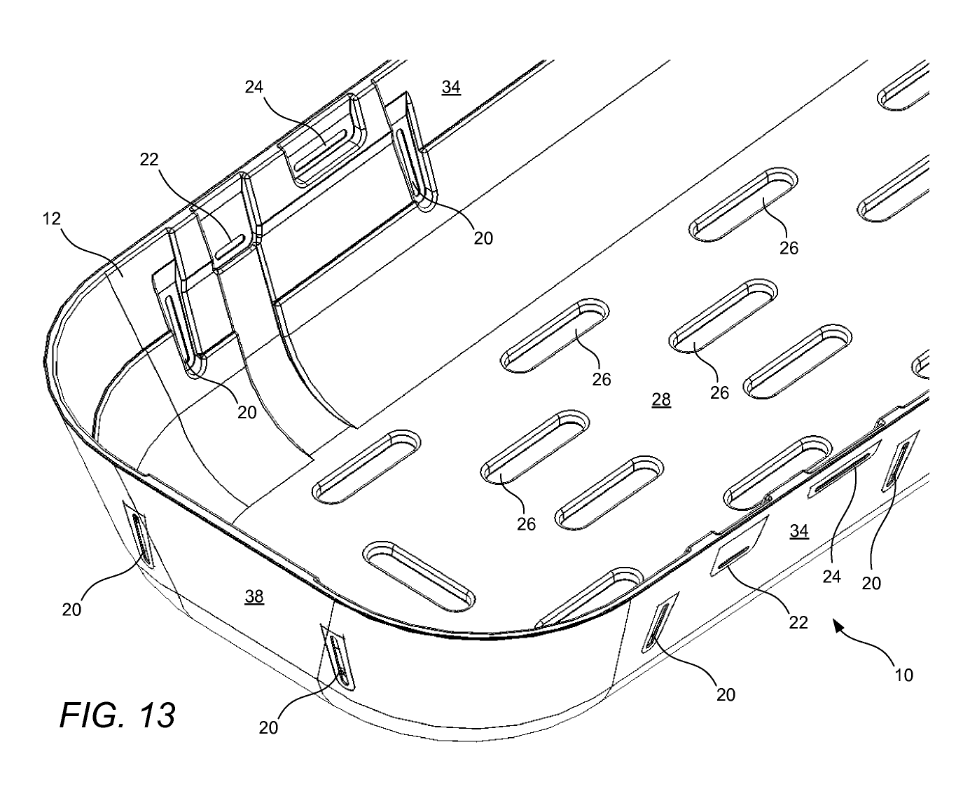

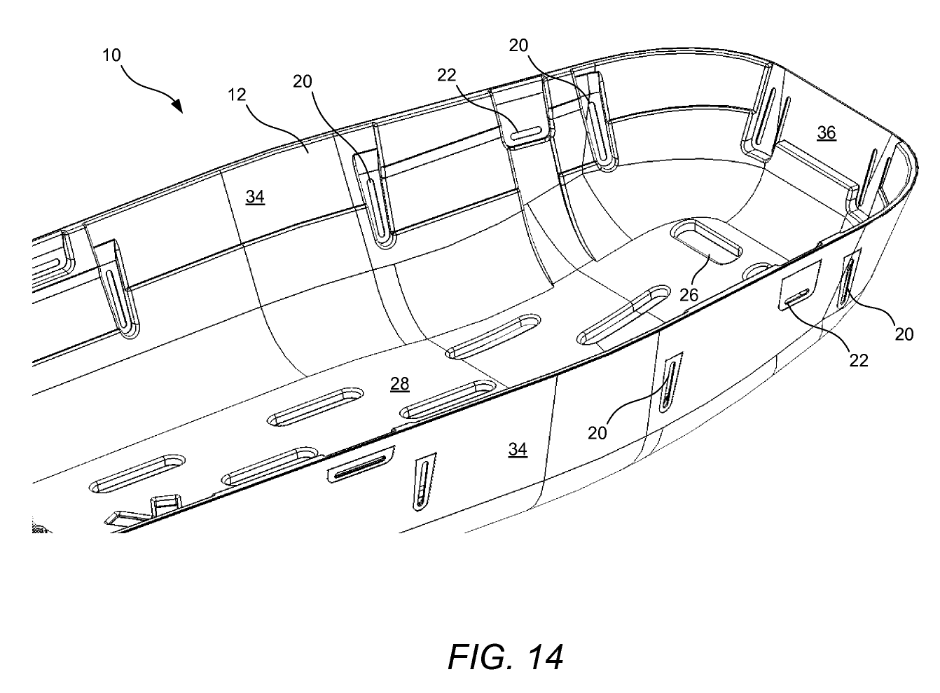

To permit the tow strap 42 to pass through the tow strap hole 22 and encircle the circumferential strap, each tow strap hole 22 is located at a position somewhere between two adjacent circumferential strap holes 20 horizontally, and somewhere between slightly above to slightly below the circumferential strap holes 20 vertically, as illustrated in the Figures, and particularly in FIGS. 13 and 14. This minimizes forces applied to the body 12 directly by the tow straps 40. If flat straps are to be used for the tow straps 42, the tow strap holes 20 may be roughly horizontal in nature, as shown in the Figures. As may be appreciated from the Figures, and particularly from FIGS. 13 and 14, the tow strap holes 22 may be located near the head and foot of the sled body 12, as the sled 10 will commonly be towed in a lengthwise direction.

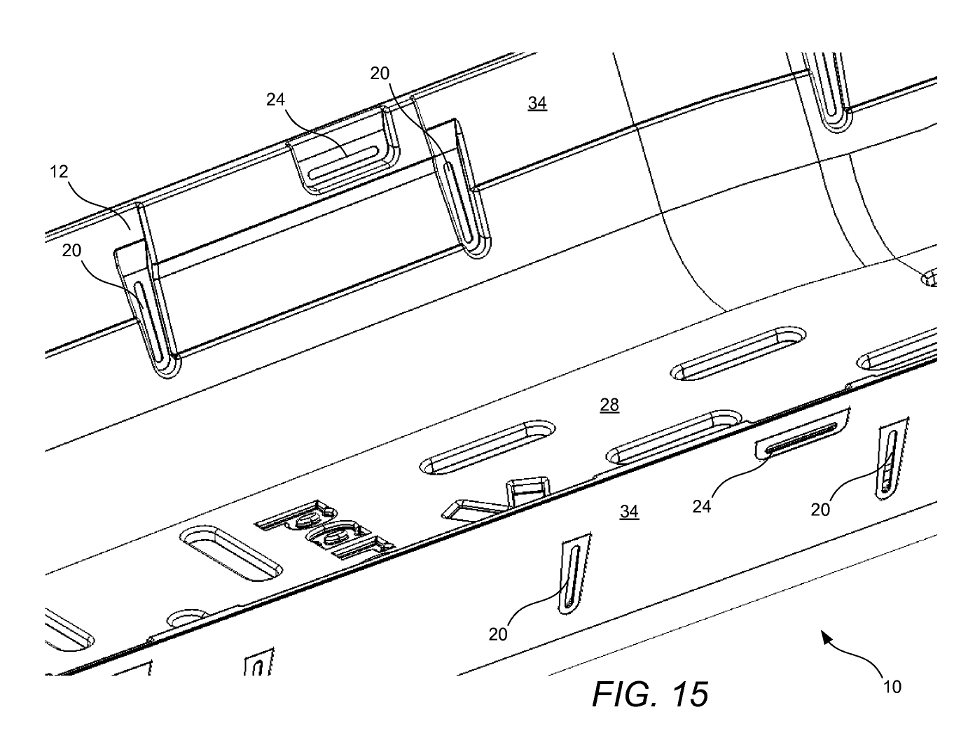

In some instances, it may be desirable to secure a person within the sled 10 so the person is safer during transportation within the sled 10. For example, it may be necessary during an evacuation procedure to ascend or descend stairways, hills, and the like, and/or to pass over rough terrain. Therefore, one or more securing straps (similar to those used on existing sleds and/or body boards) can be used to secure a person within the sled 10. Although the securing straps are not shown in the Figures, the straps may be attached to the body 12 at the securing strap holes 24 shown in the Figures, and particularly emphasized with respect to FIG. 15. Such straps may use buckles or other securing devices to connect to each other across the person within the sled 10. As may be appreciated from FIG. 15, the placement of the tow strap holes 22 may be selected to permit looping of the securing straps around the circumferential strap 40 or attaching the securing straps to the circumferential strap 40, as discussed with respect to the tow straps 42.

Each of the side portions 34, the head portion 36, and the foot portion 38 are substantially contiguous with the bottom portion 28. In addition, the two side portions 34 are substantially contiguous with the head portion 36 and are further substantially contiguous with the foot portion 38. This provides significant advantages over current evacuation sleds. For example, existing single-sheet sleds such as the Med Sled Evacuation sled provided by ARC Products of Des Peres, Mo. utilize a single flat sheet that is rolled around the person to be transported and secured by buckles. Because of the single flat sheet configuration, the Med Sled and similar products have portions of their edges essentially in contact with the ground even as a person is being transported. Thus, these products have no resistance to water or other moisture encountered as the sled is being dragged. While this may be acceptable in a situation such as a military firefight evacuation or a fire or chemical spill rescue, where the only concern is rapid evacuation, such devices are inadequate for ongoing surge capacity and many other types of evacuations, where moisture can be a big concern.

For example, in a hospital evacuation, many patients will do poorly in the event that they get wet during an evacuation, due to concerns such as evaporative cooling and inability to self regulate their temperature. Unfortunately, in many evacuation situations, the possibility of getting wet is very real. For example, in an evacuation due to fire, sprinklers may have been activated within the building, causing water to be present in the hospital halls. As another example, an evacuation may be necessary after a rain or snow event, and significant travel may be necessary over surfaces covered with rain or snow. Devices and products such as the Med Sled device are inadequate for dragging in such situations, and such devices must be carried to avoid getting the evacuee wet.

Embodiments of the inventive sled 10 do not suffer from the same failings, as the sled body 12 does not use a single flat sheet configuration as the existing sleds use. Instead, the body 12 is formed or molded into the separate but substantially-contiguous bottom portion 28, side portions 34, head portion 36, and foot portion 38. Because of this molded, non-flat configuration, the lowest point on the body 12 where water can enter the sled is the lowest of any of the circumferential strap holes 20, the tow strap holes 22, or the securing strap holes 24. In the embodiments illustrated in the Figures, the lowest of these holes are the circumferential strap holes 20. However, as may be seen from the Figures, and more particularly from FIGS. 4, 5, and 7, the lowest point of the circumferential strap holes 20 is near a vertical midpoint of the body 12, preventing water and moisture from entering the sled 10 until any water has reached a significant height up the side of the sled. In fact, in many instances the sled 10 will float before water enters the sled body 12. Additionally, the circumferential strap 40 may significantly fill the circumferential strap holes 20, thereby preventing minor splashes of water or moisture from easily passing through the circumferential strap holes 20, thereby further resisting against wetting of the person inside the sled 10. The previously-discussed resistance to abrasion further enhances this protection against wetting and further qualifies the sled 10 to provide temporary surge capacity.

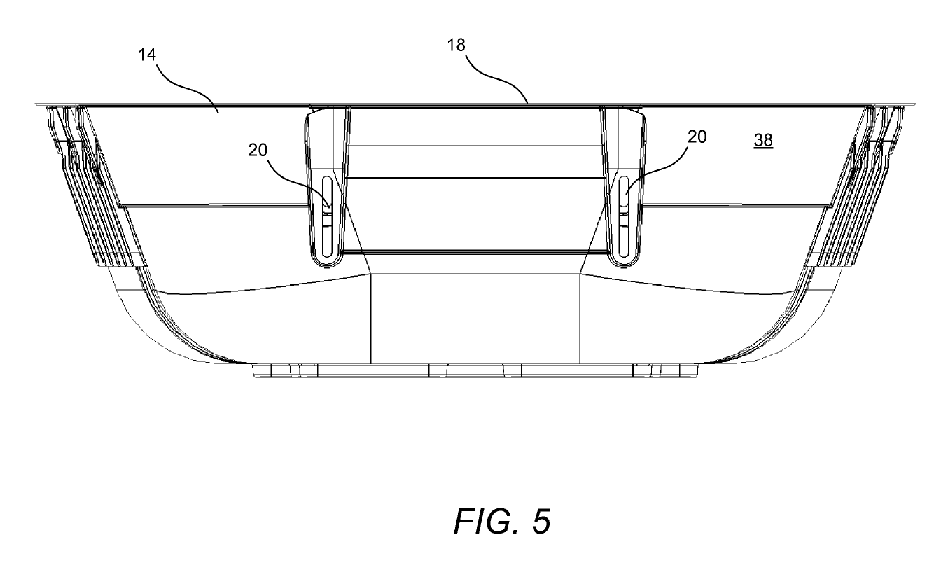

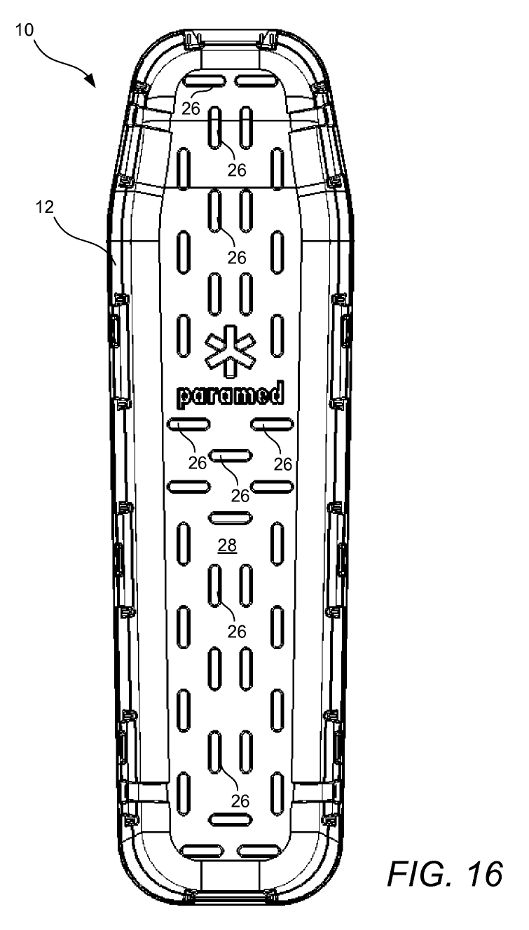

The side portions 34, the head portion 36, and the foot portion 38 are upturned from the bottom portion 28. However, the side portions 34, the head portion 36, and the foot portion 38 do not extend vertically upward from the bottom portion 28. Instead, the side portions 34, the head portion 36, and the foot portion 38 extend slightly outward from bottom to top, as may be best appreciated in the views shown in FIGS. 5 and 16, along with the cross-sectional views of FIGS. 8 and 9. This configuration allows the sled 10 to be stacked with other sleds 10, as illustrated in FIG. 11. In this way, several up to many sleds 10 can be stacked and stored in a small space for ready availability for use. When stored, the sled 10 may be stored with the circumferential strap 40, the tow straps 42 (if any) and the securing straps (if any) pre-assembled and secured to the sled 10, essentially ready to be used.

Because the sled 10 is molded or formed in the configuration shown in the Figures, and because the various straps can be stored in their use positions during storage, there are essentially no setup steps required to prepare the sled 10 for use. This is highly advantageous in an emergency, as other sleds require significant setup procedures to prepare for an evacuation. In contrast, the sled 10 can simply be removed from its storage location, brought to a person to be evacuated, and immediately used. This simplicity of steps prior to use hastens evacuations in an emergency, and may contribute to saving lives during an evacuation.

The sled described in the various embodiments above provides many advantages over other current evacuation devices. The sled is lightweight, easily and inexpensively manufactured, yet strong, rigid, and protective. The sled easily slides over the ground or around various obstacles, and has numerous points where it may be carried, dragged, or to which items may be attached. The sled also provides additional advantages, as will be described below.

It is anticipated that the sled may essentially be disposable, though it is sufficiently strong and durable that it may also be used repeatedly. Because it is manufactured at low cost, hospitals or other facilities may store enough sleds to evacuate the whole hospital or facility, stored in centrally-located locations and/or proximal to areas of anticipated need. This provides a major advantage since patients or other evacuees may remain in the sled post-evacuation. The rescuer, staff, or other people evacuating the patients need not transfer evacuees from the sleds they are in to have enough sleds to continue evacuation. Instead, each sled remains with the evacuee and performs the function of surge capacity. In fact, any unused sleds may be easily removed from the facility and set up to provide additional surge capacity until a more permanent solution can be devised. This may be particularly advantageous in the case of large-scale disasters such as earthquakes or terrorist attacks.

In fact, even if a hospital need not be evacuated, the sled may still perform the function of providing surge capacity. The hospital or other facility simply leaves its patients in their beds, removes and un-stacks the sleds, and nearly instantly has additional temporary beds for incoming patients. As the sled requires essentially no set up, preparation for any needed surge capacity is greatly reduced, even over the sleds disclosed in U.S. Pat. No. 7,422,220 to Walkingshaw et al. In this way, a hospital or other facility can function at above-normal capacity for a time during the initial response to a disaster or other large-scale need. When the need for surge capacity is over, the sleds serving as temporary beds may be stacked and stored again, or may serve as a convenient means for transporting the surge capacity patients to less-stressed facilities for more permanent treatment.

Occasionally, transport of evacuees must occur over a long horizontal distance, such as down a long hallway or away from a dangerously-damaged building. In such cases, bending over and dragging sleds by the loops in the strap or by the handles may become impractical or require a great deal of effort. To reduce the strain of long-distance hauling of evacuees in the sled, a harness may be provided to be worn by the person dragging the sledded evacuee. One sample harness for such use is shown in and discussed with reference to FIG. 8 of U.S. Pat. No. 7,422,220 to Walkingshaw et al., which Figure and discussion are incorporated herein by specific reference.

One situation where additional individuals for towing might be useful is in the case of patients needing intensive care and large amounts of equipment to ensure survival. Examples of patients requiring additional equipment for care include patients in intensive care units (ICUs), thoracic patients, and shock trauma patients. For some patients, the equipment necessary to ensure survival may be bulkier and heavier than the patient/evacuee him or herself. In such a case, the sled provides advantages previously unknown in the art. For such patients, a second and even a third sled may be provided in addition to the first sled containing the patient. The additional sled(s) may be fitted with a form-fitting foam insert that completely fills the sled to prevent unwanted movement of support equipment. The foam insert may have fitted foam cutouts that precisely fit the semi-portable equipment necessary to ensure survival of the evacuees needing intensive care. The sleds can then be dragged together to continue critical life support functions at all times. Such inserts can also be provided for infants and small children, allowing the evacuee and some support equipment to be transported in the same sled. Support equipment may also be transported on top of or next to an evacuee inside a sled.

When multiple sleds are being transported together, such as for critical-care patients, the sleds may be attached to one another in daisy-chain fashion, or may be attached side-by-side to prevent disruption of critical care services. This is possible due to the narrow profile of the sleds, in contrast to the wide profile of many hospital beds that might otherwise be used for evacuation. To attach sleds, a portion of the different sleds are simply attached to one another in any fashion. Then the multiple sleds may be moved as a unit, and may remain with an evacuated patient to serve as surge capacity and continued care until more permanent facilities may be reached. In this way, many critical care patients that might otherwise perish in the event of a major emergency will be better able to survive the emergency until the reestablishment of a proper critical care environment.

Another advantage of the sled is its ability to provide controlled descents down stairways with a single individual, no matter how heavy the evacuee. To accomplish this, a belay device commonly used in rock climbing is located at the top of stairways to be descended. This device may be permanently provided at this location, or may be provided with the sled and attached at the top of the stairway as needed in an emergency. Usually, one belay device is used per flight of stairs to be descended. The evacuee is transported by carrying or dragging to the top of a flight of stairs, and a climbing rope is attached at the head of the sled and then through the belay device. An 8-mm climbing rope has been found to be sufficient for the task in most instances. For simplicity and rapidity of evacuation, a rope may be provided attached to each sled and then quickly placed in the belay device as each evacuee arrives at the top of the stairs.

After the belay device is attached to the rope, the sled is pushed or pulled over the top of the stairs until the patient's weight starts the sled sliding down the stairs. As this is done, the person activating the belay device allows a controlled amount of rope to pass through the device as needed to allow the sled to move to the edge of the stairs. As the sled starts to slide down the stairs, the person continues to control the amount of rope passing through the belay device, readily controlling the descent down the stairs. Thus the sledded evacuee may readily and safely descend a stairway or hill of almost any size and steepness.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A dual-layer molded and stackable evacuation sled comprising:
a dual-layer molded sled body comprising:
an inner layer;
an outer layer fixedly connected to the inner layer;
an air space between the inner layer and the outer layer;
a low-friction bottom surface of the outer layer;
a bearing surface having a length and width that renders the bearing surface capable of receiving a human in a prone position;
an upturned head portion that is substantially contiguous with the bearing surface and that is located at a head end of the bearing surface;
a pair of upturned side portions that are substantially contiguous with the bearing surface and the head portion;
an upturned foot portion that is substantially contiguous with the bearing surface and the side portions and that is located at a foot end of the bearing surface;
a top edge where outermost portions of the inner layer and outer layer meet, the top edge extending around top ends of the head portion, the side portions, and the foot portion; and
a plurality of holes formed in at least the side portions, the holes being adapted to receive a strap.

2. A sled as recited in claim 1, further comprising a circumferential strap threaded through at least a portion of the plurality of holes in a fashion to be useable as handles for human hands.

3. A sled as recited in claim 2, wherein the circumferential strap comprises a length sufficient to form a loop external to the sled body for towing the sled.

4. A sled as recited in claim 2, further comprising a tow strap threaded through one of the holes and looped around the circumferential strap, whereby any towing force applied to the tow strap is passed to the circumferential strap, which distributes any towing forces passed to the circumferential strap by the tow strap around the sled body.

5. A sled as recited in claim 2, further comprising a plurality of tow straps, each threaded through one of the holes and looped around the circumferential strap, whereby any towing force applied to the tow straps is passed to the circumferential strap and distributed around the sled body.

6. A sled as recited in claim 1, wherein the inner layer and the outer layer are fixedly joined to each other proximate each of the holes, forming structure maintaining the air space around each of the holes.

7. A sled as recited in claim 6, wherein the inner layer and the outer layer are also fixedly joined to each other at a plurality of spacing indentations in one of the inner layer and the outer layer, thereby forming structures maintaining the air space along a bottom of the sled body.

8. A sled as recited in claim 1, wherein center points of each of the holes are each located at or above a vertical midline of the sled.

9. A sled as recited in claim 1, wherein the holes comprise a plurality of vertical circumferential strap holes and a plurality of horizontal tow strap holes.

10. A sled as recited in claim 1, wherein the head portion, the side portions, and the foot portion extend upward and outward from the bearing surface, whereby a plurality of the sleds can be stacked and nested together.

11. A dual-layer molded and stackable evacuation sled comprising:
a dual-layer molded sled body comprising:
an inner layer;
an outer layer fixedly connected to the inner layer;
an air space between the inner layer and the outer layer;
a low-friction bottom surface of the outer layer;
a bearing surface having a length and width that renders the bearing surface capable of receiving a human in a prone position;
an upturned head portion that is substantially contiguous with the bearing surface and that is located at a head end of the bearing surface;
a pair of upturned side portions that are substantially contiguous with the bearing surface and the head portion;
an upturned foot portion that is substantially contiguous with the bearing surface and the side portions and that is located at a foot end of the bearing surface;
a top edge where outermost portions of the inner layer and outer layer meet, the top edge extending around top ends of the head portion, the side portions, and the foot portion; and
a plurality of holes formed in at least the side portions; and
a circumferential strap threaded through at least a portion of the plurality of holes in a fashion to be usable as handles for human hands.

12. A sled as recited in claim 11, further comprising a plurality of tow straps, each threaded through one of the holes and looped around the circumferential strap, whereby any towing force applied to the tow straps is passed to the circumferential strap and distributed around the sled body.

13. A sled as recited in claim 11, wherein the inner layer and the outer layer are fixedly joined to each other proximate each of the holes, forming structure maintaining the air space around each of the holes.

14. A sled as recited in claim 13, wherein the inner layer and the outer layer are also fixedly joined to each other at a plurality of spacing indentations in one of the inner layer and the outer layer, thereby forming structures maintaining the air space along a bottom of the sled body.

15. A sled as recited in claim 11, wherein center points of each of the holes are each located at or above a vertical midline of the sled.

16. A sled as recited in claim 11, wherein the holes comprise a plurality of vertical circumferential strap holes and a plurality of horizontal tow strap holes.

17. A sled as recited in claim 11, wherein the inner layer and the outer layer are formed of plastic materials.

18. A sled as recited in claim 11, wherein the inner layer and the outer layer are formed of polypropylene.

19. A dual-layer molded and stackable evacuation sled comprising:
a dual-layer molded sled body comprising:
an inner layer;
an outer layer fixedly connected to the inner layer;
an air space between the inner layer and the outer layer;
a low-friction bottom surface of the outer layer;
a bearing surface having a length and width that renders the bearing surface capable of receiving a human in a prone position;
an upturned head portion that is substantially contiguous with the bearing surface and that is located at a head end of the bearing surface;
a pair of upturned side portions that are substantially contiguous with the bearing surface and the head portion;
an upturned foot portion that is substantially contiguous with the bearing surface and the side portions and that is located at a foot end of the bearing surface;
a top edge where outermost portions of the inner layer and outer layer meet, the top edge extending around top ends of the head portion, the side portions, and the foot portion; and
a plurality of circumferential strap holes formed in at least the side portions;
a circumferential strap threaded through at least some of the plurality of circumferential strap holes in a fashion to be usable as handles for human hands; and
a tow strap threaded through a tow strap hole and looped around the circumferential strap, whereby any towing force applied to the tow strap is passed to the circumferential strap, which distributes any towing forces passed to the circumferential strap by the tow strap around the sled body.

20. A sled as recited in claim 19, wherein the head portion, the side portions, and the foot portion extend upward and outward from the bearing surface, whereby a plurality of the sleds can be stacked and nested together.
